(19) United States
(12) Patent Application Publication
(10) Pub. No.: US 2022/0340176 A1
(43) Pub. Date: Oct. 27, 2022

(54) Enhanced Ridehail Systems And Methods

(71) Applicant: Ford Global Technologies, LLC, Dearborn, MI (US)

(72) Inventors: Aaron Haubert, Grosse Point, MI (US); Krishnaswamy Venkatesh Prasad, Ann Arbor, MI (US)

(73) Assignee: Ford Global Technologies, LLC, Dearborn, MI (US)

(21) Appl. No.: 17/241,747

(22) Filed: Apr. 27, 2021

(51) Int. Cl. B60W 60/00; G06K 9/00; G06Q 10/06; B60R 25/24; B60Q 1/50

(52) U.S. Cl. CPC B60W 60/00253; G06K 9/00791; G06K 9/00369; G06K 9/00355; G06Q 10/0631; B60R 25/24; B60Q 1/503; B60W 2540/041; B60W 2540/223; B60W 2556/65; B60W 2420/42

(57) ABSTRACT

Enhanced ridehail systems and methods are disclosed herein. A method can include determining a pattern of a patterned object associated with a ridehail stand from images obtained by a vehicle camera, determining presence of a user at the ridehail stand using the images when at least a portion of the patterned object is being obscured by the user or when the user is detected using a sensor of the vehicle, and causing the vehicle to stop at the ridehail stand when the presence of the user is determined.

### BACKGROUND

It would be advantageous for the autonomous vehicles (Avs) to provide taxi services and mimic how they are used by patrons. While ride-hailing services offer some promise, they are dependent upon a digital hail action through the use of an application executing on a mobile device of a user, such as a smartphone. That is, the user can hail a ride with an AV by requesting service from a ridehail service application on their mobile device. This dependency means that a customer with a dead phone battery is unable to access a ridehail service, especially an autonomous ridehail vehicle. Further, a customer without a phone is unable to access the ridehail service at all.

### BRIEF DESCRIPTION OF THE DRAWINGS

The detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example architecture where the systems and method of the present disclosure may be practiced.

FIG. 2 is an example schematic diagram of a scenario where aspects of the present disclosure may be practiced.

FIG. 3 is another example schematic diagram of a scenario where aspects of the present disclosure may be practiced.

FIG. 4 is a flowchart of an example method of the present disclosure.

FIG. 5 is a flowchart of another example method of the present disclosure.

### DETAILED DESCRIPTION

### Overview

The present disclosure generally pertains to enhanced ride-hailing systems and methods that can provide equitable services to all passengers. In some instances, these enhanced services can include dedicated autonomous ride-hail vehicle stands that allow customers to request autonomous ride-hail vehicles on the street without requiring the use of a smartphone. The dedicated stands may be placed in a geographic area, with the GPS coordinates of the stands registered and mapped into navigation systems of the AVs. In other instances, patterns can be displayed on smart devices or placards, cards, signs, or other physical structures.

A ridehail stand may include a patterned signal that the AVs can be trained to recognize. Vehicles that are not currently being routed to a customer can enter into a holding pattern route in which they move towards the most likely pick-up areas. An AV of the present disclosure may be “hailed” in a manner similar to a normal taxi with a human driving. The AV can leverage visual or (Infrared) IR cameras to detect the patterned sign and/or human signaling from the customer requesting the ride. In another example, light detection and ranging (LIDAR) devices may also be used by an AV to detect a human, and/or bodily movement indicative of a hailing gesture (such as a hand wave), nearby the sign. The AV may then recognize it is being hailed, pull over, and ask for input from the potential rider. Input is requested to ensure the AV didn't make an error and to prevent an attempt by the potential customer to enter the AV without paying.

### Illustrative Embodiments

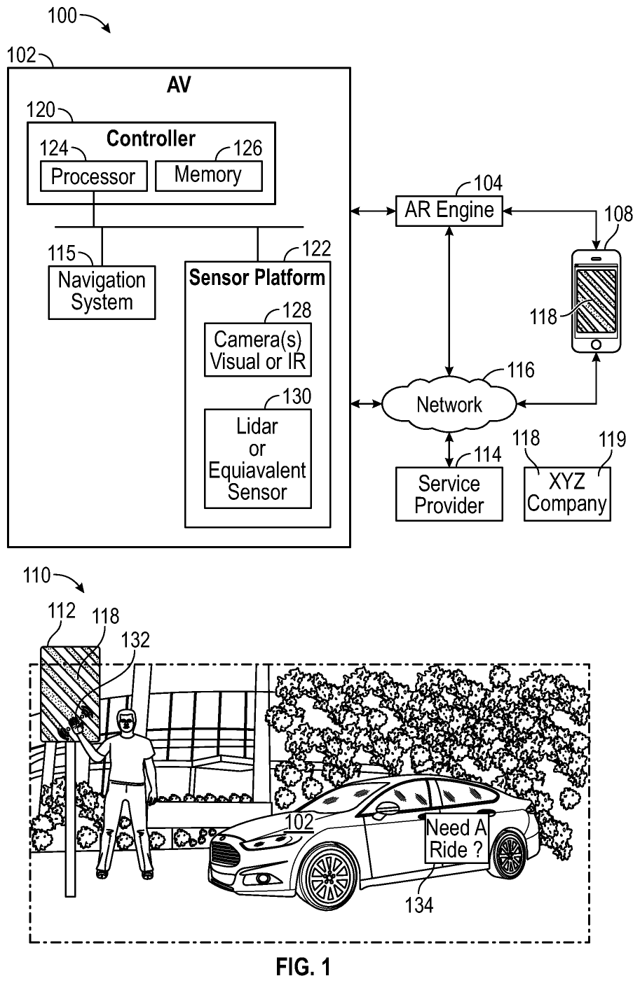

Turning now to the drawings, FIG. 1 depicts an illustrative architecture 100 in which techniques and structures of the present disclosure may be implemented. The architecture 100 can include an AV 102 (may be interchangeably referred to as AV or vehicle), a distributed augmented reality (AR) engine (hereinafter AR engine 104), user equipment (UE 108), a ridehail stand 110 with patterned sign 112, a service provider 114, and a network 116. Some or all of these components in the architecture 100 can communicate with one another using the network 116. The network 116 can include combinations of networks that enable the components in the architecture 100 to communicate with one another. The network 116 may include any one or a combination of multiple different types of networks, such as cable networks, the Internet, wireless networks, and other private and/or public networks. In some instances, the network 116 may include cellular, Wi-Fi, or Wi-Fi direct.

The ridehail stand 110 can include any designated area that is adjacent to a street, parking lot, building, or any other location where a user (e.g., passenger) may be picked up for a ridehail service. The location of the ridehail stand 110 may be predetermined by a ridehail service and/or municipality. A location of the ridehail stand 110 may be determined and stored in a database maintained by the service provider 114. The location of the ridehail stand 110 (as well as other ridehail stands in the location of the AV 102) can be stored by the AV 102 as well. In some instances, the service provider 114 can transmit the location of the ridehail stand 110 to the AV 102 for use in a navigation system 115 of the AV 102. In addition to using location information such as Global Positioning System (GPS) coordinates, additional ridehail stand information can be included such as cardinal directions of the ridehail stand relative to intersections or other landmarks, as well as which side of the street a ridehail stand is located on when such ridehail stand is adjacent to a street. Detailed orientation information for the ridehail stand 110 may be referred to generally as ridehail stand orientation or hyper-localization.

The patterned sign 112 can include a substrate having a particular pattern 118 provided thereon. The particular aesthetic details of the pattern 118 can vary according to design requirements, but in the example provided, the pattern includes alternating yellow and black stripes that are oriented at an angle (e.g., for example, a 45-degree slant). It will be understood that while an example pattern has been illustrated, the patterned sign 112 can include any pattern that AV systems can be trained to recognize. Also, while a pattern sign has been described, other patterned objects other than signs can be used. For example, a pattern used to indicate a ridehail location could be printed on the side of a building or another structure. As will be discussed in greater detail below, rather than using a patterned sign, a user can flag down the AV 102 using a patterned image displayed on their UE 108. For example, when the UE 108 is a smartphone, the pattern 118 can be displayed on the screen of the smartphone. Furthermore, the display of a pattern on the UE 108 can allow for use of a dynamic or unique pattern that can change. A digital pattern can also include a coded, structured pattern that can embed other types of information such as information about the user (e.g., a user profile, preferences, payment information, and the like). While a smartphone has been disclosed, other devices can be used such as smartwatches, tablets, and the like.

In an analog example, the pattern 118 can be printed on a card that is carried by the user. The user can hold out the card to flag down the AV 102. In this way, the ridehail stand is portable and can be carried by the user. The user need not find a patterned sign or ridehail stand, but can instead use their UE or card to request the AV 102 service at any location. The examples provided herein are not intended to be limiting and provided for illustrative purposes. Other configurations of mechanisms or methods of displaying a pattern that can be recognized by the AV 102 as a ridehail request can likewise be utilized.

In some instances, the pattern 118 is selected in its composition of colors and/or aesthetics so that when reversed, the pattern 118 is not displayed so as to prevent confusion by the AR engine 104. In one example, a negative 119 of the pattern 118 could include a message, such as an advertisement for XYZ Company. The patterned sign 112 may be illuminated with a light to make it more visible in low light conditions.

The AV 102 generally comprises a controller 120 and a sensor platform 122. The controller 120 can comprise a processor 124 and memory 126 for storing executable instructions, the processor 124 can execute instructions stored in memory 126 for performing any of the enhanced ridehail features disclosed herein. When referring to operations performed by the controller 120, it will be understood that this includes the execution of instructions stored in memory 126 by the processor 124. The AV 102 can also include a communications interface that allows the controller 120 to transmit and/or receive data over the network 116.

The sensor platform 122 can include one or more camera(s) 128 and a LIDAR 130. The one or more camera(s) 128 can include visual and/or infrared cameras. The one or more camera(s) 128 obtain images that can be processed by the AR engine 104 to determine if a ridehail stand is present in the images and/or when a passenger is present at the ridehail stand.

The LIDAR sensor 130 can be used to detect a distance between objects (such as between the AV and the patterned sign, and between the AV and a user waiting near the patterned sign) and/or movement of objects, such as users in the images. The one or more camera(s) 128 can include visual and/or infrared cameras. The one or more camera(s) 128 obtain images that can be processed by the AR engine 104 to determine if a ridehail stand is present in the images and/or when a passenger is present at the ridehail stand.

The controller 120 can be configured to cause the AV 102 to traverse a holding or circling pattern around the ridehail stand 110 when awaiting a ridehail request from a user. The AV 102 could be instructed to drive in a pre-determined pattern around the ridehail stand 110 or a set of ridehail stands using the navigation system 115. Alternatively, the AV 102 could be instructed to park until a ridehail request is received. In some instances, the circling or driving pattern followed by the AV 102 can be based on historical or expected use patterns as determined by the service provider 114. That is, the service provider 114 can transmit signals to the controller 120 to operate the AV 102 based on historical ridehail patterns. In other examples, the AV 102 can drive a pattern around known locations of ridehail stands.

As noted above, the controller 120 can maintain a list of locations where ridehail stands are located in a given area. As the AV 102 approaches a ridehail stand, the controller 120 may cause the one or more camera(s) 128 to obtain images. The images can be transmitted by the controller 120 over the network to 116 to the AR engine 104 for processing. The AR engine 104 can return a signal to the controller 120 to indicate whether a user is present and attempting to hail the AV 102 from the ridehail stand 110.

The AR engine 104 can be configured to provide features such as scene recognition (identifying objects or landmarks in images), user gesture (e.g., hand waive), gait recognition, and/or group biometrics. Collectively, these data can be used to determine a context for a user by the AR engine 104. Additional details regarding user context are provided in greater detail infra.

For example, images can be processed by the AR engine 104 to determine the presence of a ridehail stand (or lack thereof) in the images. This can include the AR engine 104 detecting the pattern 118 of the patterned sign 112. When the sign is detected, the AR engine 104 can also determine when a user is hailing the AV 102. In one example, a user can wave a hand 132 in front of the pattern 118 of the patterned sign 112, partially obscuring the pattern 118. The AR engine 104 can determine that an object that is shaped like a human hand is obscuring a portion of the pattern 118. In some instances, the AR engine 104 can detect a waiving or other similar motion of the hand 132 using multiple images. In another example, the user can hold any object against the pattern 118 to obscure a portion of the pattern 118. If any portion of the pattern 118 is obscured the AR engine 104 can determine that a user is present in the patterned sign 112. As noted above, the AV 102 can include LIDAR or other types of non-visual-based sensors that can detect object presence and movement. In some instances, the presence of a user at the ridehail stand 110 can be determined by the AR engine 104 using one or more presence and/or movement detection sensors. In some instances, the AR engine 104 can determine relative distances between users, the AV 102, and the patterned sign 112. For example, the AR engine 104 can determine a distance between the AV 102 and the patterned sign 112. The AR engine 104 can then determine a distance between the user and the patterned sign 112. When these two distance calculations are within a specified range (e.g., zero to five feet, but can be adjusted based on desired sensitivity), the AR engine 104 may determine that the user is at the ridehail stand 110 and is awaiting service.

In addition to determining user presence and intent, the AR engine 104 may also be configured to evaluate the images for scene recognition where the AR engine 104 detects background information in the images such as buildings, streets, signs, and so forth. The AR engine 104 can also be configured to detect gestures, posture, and/or gate (e.g., bodily movement) of the user. For example, the AR engine 104 can detect that the user is stepping forward as the AV 102 gets closer to the ridehail stand 110, which may indicate that the user intended to hail the AV 102. The AR engine 104 can also detect multiple users as noted above, along with biometrics of users.

Also, the AR engine 104 can be configured to determine a context for the user. In general, the context is indicative of specific user requirements for the AV 102. For example, the AR engine 104 can detect from the images that multiple users are present. The AV 102 may be prompted to ask the user or users if a pooling service is needed. Multiple users may also be indicative of a family. In another example, the context could include determining a wheelchair or stroller in the images. The controller 120 can request information from the user that confirms if special accommodations are needed for a group of people or for transportation of bulky items such as strollers, wheelchairs, packages, and other similar objects. The controller 120 can be configured to determine when the context indicates that the AV 102 can or cannot accommodate the user(s).

When a user is detected at the ridehail stand 110 and the AR engine 104 has determined that the user is or is likely attempting to hail the AV 102, the AR engine 104 transmits a signal to the AV 102 that is received by the controller 120. The signal indicates to the controller 120 whether the AV 102 should stop at the ridehail stand 110 or not. In some instances, the functionalities of the AR engine 104 can be incorporated into the AV 102. That is, the controller 120 can be programmed to provide the functionalities of the AR engine 104.

The controller 120 can instruct the AV 102 to stop at the ridehail stand 110. In some instances, the controller 120 can cause an external display 134 (e.g., a display mounted on the outside of the AV) of the AV 102 to display one or more graphical user interfaces that ask a user to confirm whether they need ridehail services or not. The controller 120 can cause the external display 134 to ask the user for an intended destination, for a form of payment, or any other prompt that would instruct the controller 120 as to the intentions of the user (e.g., did the user intend to hail the AV or not). While the use of an external display has been disclosed, other methods for communicating with the user to determine user intent can be used such as audible messages broadcast through a speaker. The AV 102 can be enabled with speech recognition to allow the user to speak their intent using natural language speech.

Receiving input and confirmation prior to a user entering the AV 102 may ensure that the AV 102 did not erroneously stop for a user who was not interested in using the AV 102, or any other generalized error causing the AV 102 to stop at the ridehail stand 110 when the user did not request the AV 102 to stop. Obtaining user confirmation or payment before allowing the user to enter the AV 102 may also prevent attempts by users to take over the AV and gain shelter without authorization, which would be disruptive to the AVs functionality and the service overall.

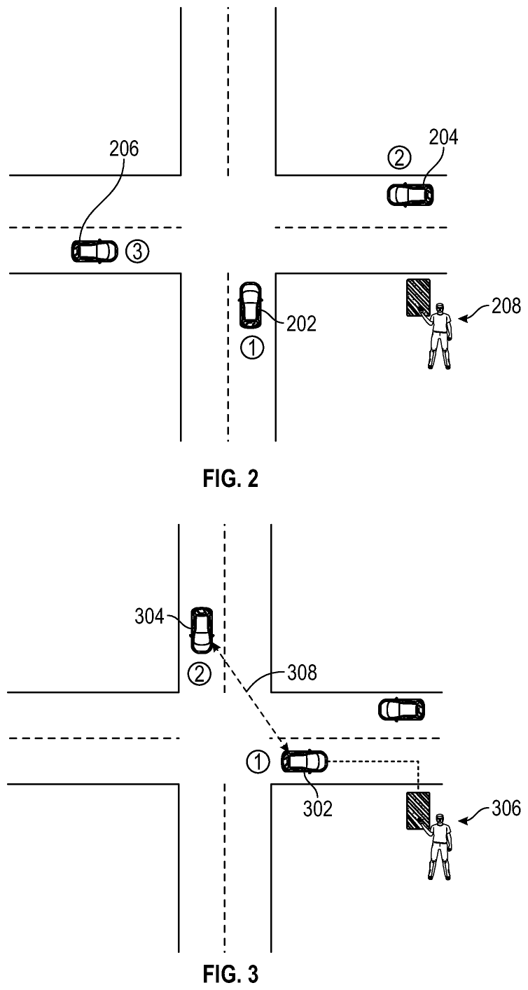

FIG. 2 provides an example where a relative location of a ridehail stand relative to a street can be used to select an appropriate AV when more than one AV is operating in a geographical location. To be sure, each of the AVs is configured as disclosed above with respect to the AV 102 of FIG. 1. In this example, three AVs 202, 204, and 206 are performing circling patterns around a ridehail stand 208. AV 202 is making a right-hand turn and would be on the correct side of the street to be hailed. Again, each of the AVs can be provisioned with hyper-localized information regarding the location of the ridehail stand 208. Due to this hyper-localized information, the AV 204 would determine that it is on the wrong side of the street. The AV 204 may disregard any hailing user and would continue searching for a passenger or another ridehail stand. Again, any of the AVs can be configured to detect patterned objects displayed on UEs or other physical objects that may indicate that a user is requesting service.

Also, the AV 206 approaching the intersection would recognize the hail attempt by the user. The AV 202 and the AV 206 could coordinate pick up, or default to a first arrive, first pick-up scenario. For example, if the timing of the lights at the intersection results in the AV 206 arriving at the ridehail stand 208 first, the AV 206 would pick up the user. In a further process, if the AV 206 determines that a context of the user indicates multiple riders or bulky items, the AV 206 can coordinate with the AV 202 to transport the user(s) and/or their cargo in tandem. The AVs can coordinate their actions through a service provider (see service provider 114 of FIG. 1 as an example) or through a vehicle-to-vehicle (V2V) connection over the network 116.

FIG. 3 provides an example of cooperative behavior between two AVs. To be sure, each of the AVs is configured as disclosed above with respect to the AV 102 of FIG. 1. AVs 302 and 304 are operating in an area around a ridehail stand 306. It will be assumed for this example that the AV 302 is full and/or is on a trip for a passenger who prefers to ride alone (e.g., not a pooled service). The AV 302 detects that a user is attempting to hail the AV 302 for a ridehail trip. The AV 302 can coordinate with the AV 304 to pick up the user. For example, the AV 302 can transmit a signal to the AV 304 over a V2V or other similar wireless connection 308 that indicates that a user is requesting a ride. The signal can indicate a location or identifier of the ridehail stand 306 and/or any images or contextual information obtained as the AV 302 drives by the ridehail stand 306. The AV 304 can pre-process images of the ridehail stand 306 obtained by the AV 302 so that the AV 304 can determine if it can service the user. For example, the AV 304 can evaluate the images and determine if the context of the user corresponds with the capabilities or capacity of the AV 304. If the user has bulky items, the AV 304 can determine if it has capacity for both the user and their bulky items. In another example, the AV 304 can determine if it has seating capacity for multiple users when the context indicates that multiple users are requesting a ride.

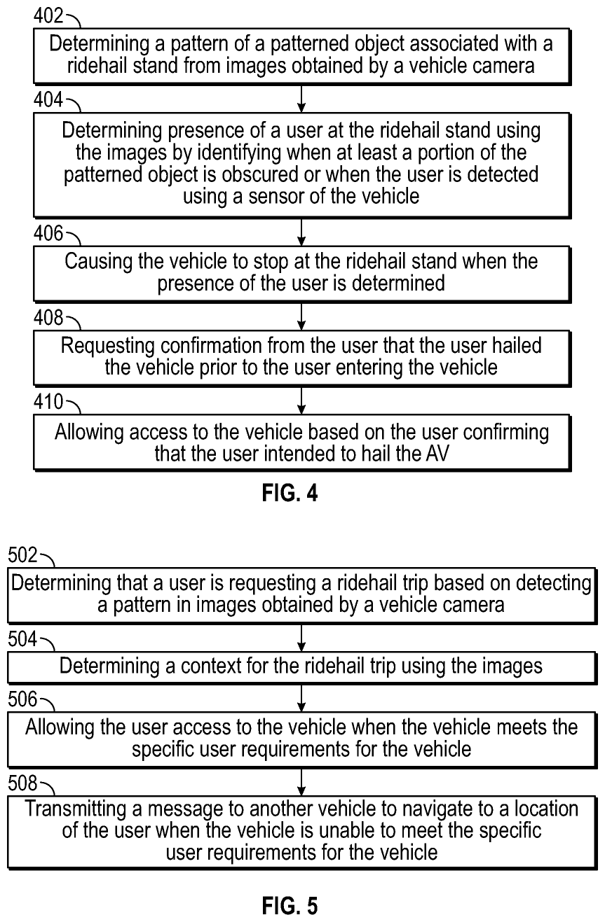

FIG. 4 is a flowchart of an example method of the present disclosure. The method can include a step 402 of determining a pattern of a patterned object associated with a ridehail stand from images obtained by a vehicle camera. The pattern object can be a sign in some instances. As noted above, the AV can be configured to drive in a predetermined pattern that causes the AV to pass ridehail stands. For example, a controller can be configured to cause the vehicle to traverse a pattern around the ridehail stand until the user is detected at the ridehail stand. Each of the ridehail stands can be provided with a patterned sign that includes a unique pattern. Each ridehail stand can be identified by its location, along with a ridehail stand orientation (e.g., hyper-localization). The locations can be mapped for use in a navigation system of the AV. Thus, the predetermined pattern may be based on the mapped locations of the ridehail stand(s).

Next, the method includes a step 404 of determining the presence of a user at the ridehail stand using the images by identifying when at least a portion of the patterned object is obscured or when the user is detected using a sensor of the vehicle. In one example, the user can obscure a portion of the patterned object with their hand or another object. For example, determining the presence of the user may include determining that a hand of the user is being waived in front of the patterned sign. In another example, a portion of the patterned object may be obscured when the user stands next to the patterned object and their body is positioned between the AV and the patterned object. In another scenario, the presence of the user can be determined based on user proximity to the AV and/or the patterned object. For example, it may be determined that the AV is 200 yards from the patterned object and that a user is 196 yards from the AV. This distance indicates that the user in close proximity to the patterned object and is likely waiting for ridehail service. Next, the method can include a step 406 of causing the vehicle to stop at the ridehail stand when the presence of the user is determined.

The method can include a step 408 of requesting confirmation from the user that the user hailed the vehicle prior to the user entering the vehicle. If the user did not intend to hail the AV, the AV can return to its predetermined driving pattern to await another ridehail opportunity. When the user has intended to request service, the method can include a step 410 of allowing access to the vehicle based on the user confirming that the user intended to hail the AV. In some instances, this can include the user paying or being otherwise authorized to enter the AV.

FIG. 5 is another flowchart of an example method. The method can include a step 502 of determining that a user is requesting a ridehail trip based on detecting a pattern in images obtained by a vehicle camera. In some instances, the images can be obtained by a vehicle based on proximity to mapped location that is associated with a ridehail stand.

In other instances, the vehicle can continually use the cameras to obtain images and evaluate the images to detect patterns that indicate that a user is requesting a ridehail trip. Some examples include detecting a patterned sign, a pattern displayed on a screen of a smart device, a placard or card held by a user, and so forth.

The method can also include a step 504 of determining a context for the ridehail trip using the images. Again, the context may be indicative of specific user requirements for the vehicle such as vehicle capacity (e.g., rider count), storage or luggage capacity, and/or handicap accessibility requirements. Determinations of user presence and context may be accomplished using an AR engine that is located at a service provider and/or as a network-accessible service. The AR engine may be localized at the vehicle level.

The method can include a step 506 of allowing the user access to the vehicle when the vehicle meets the specific user requirements for the vehicle. In some instances, the user may be allowed to access the vehicle after payment information has been received by the vehicle. Next, the method may include a step 508 of transmitting a message to another vehicle to navigate to a location of the user when the vehicle is unable to meet the specific user requirements for the vehicle.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method comprising:
determining a pattern of a patterned object associated with a ridehail stand from images obtained by a camera of a vehicle;
determining presence of a user at the ridehail stand using the images by identifying when at least a portion of the patterned object is obscured or when the user is detected using a sensor of the vehicle; and
causing the vehicle to stop at the ridehail stand when the presence of the user is determined.

2. The method according to claim 1, further comprising:
requesting confirmation from the user that the user hailed the vehicle prior to the user entering the vehicle; and
allowing access to the vehicle based on the user confirming that the user intended to hail the vehicle.

3. The method according to claim 1, wherein determining the presence of the user includes determining that a hand of the user is being waived in front of the patterned object that is a patterned sign.

4. The method according to claim 1, further comprising determining a location of the ridehail stand, along with a ridehail stand orientation.

5. The method according to claim 4 further comprising mapping the ridehail stand for use in a navigation system of the vehicle.

6. The method according to claim 1, further comprising causing the vehicle to traverse around the ridehail stand until the user is detected at the ridehail stand.

7. The method according to claim 1, further comprising detecting a gesture by the user that is indicative of an intent of the user to hail the vehicle.

8. A system, comprising:
a processor; and
a memory for storing instructions, the processor executing the instructions to:
determine a pattern of a patterned object associated with a ridehail stand from images obtained by a camera of a vehicle;
determining presence of a user at the ridehail stand using the images by identifying when at least a portion of the patterned object is obscured or when the user is detected using a sensor of the vehicle; and
cause the vehicle to stop at the ridehail stand when the presence of the user is determined.

9. The system according to claim 8, wherein the processor is further configured to:
request confirmation from the user that the user hailed the vehicle prior to the user entering the vehicle by displaying a message on an external display of the vehicle; and
allow access to the vehicle based on the user confirming that the user intended to hail the vehicle.

10. The system according to claim 8, wherein the processor is further configured to determine that a hand of the user is being waived in front of the patterned object that is a patterned sign.

11. The system according to claim 8, wherein the processor is further configured to determine a location of the ridehail stand, along with a ridehail stand orientation and map the ridehail stand for use in a navigation system of the vehicle.

12. The system according to claim 8, wherein the processor is further configured to cause the vehicle to traverse around the ridehail stand until the user is detected at the ridehail stand.

13. The system according to claim 8, wherein the processor is further configured to detect a gesture by the user that is indicative of an intent of the user to hail the vehicle.

14. The system according to claim 8, wherein the processor is further configured to:
determine that the vehicle is unable to serve the user; and
transmit a signal or message to another vehicle to navigate to the ridehail stand to pick up the user.

15. A system comprising:
a processor; and
a memory for storing instructions, the processor executing the instructions to:
determine that a user is requesting a ridehail trip based on detecting a pattern in images obtained by a camera of a vehicle;
determine a context for the ridehail trip using the images, the context being indicative of specific user requirements for the vehicle;
allow the user enter the vehicle when the vehicle meets the specific user requirements for the vehicle; and
transmit a message to another vehicle to navigate to a location of the user when the vehicle is unable to meet the specific user requirements for the vehicle.

16. The system according to claim 15, wherein the pattern is included on a patterned sign of a ridehail stand.

17. The system according to claim 15, wherein the pattern is displayed on a screen of a smart device.

18. The system according to claim 15, wherein the pattern is included on a physical object held by the user.

19. The system according to claim 15, wherein a negative of the pattern can be determined by the camera, the negative of the pattern including a communication.

20. The system according to claim 15, further comprising an augmented reality engine that is configured to determine any one or more of scene recognition, user gesture and gait, group data, and biometric data, the context being based in part on output of the augmented reality engine.
